(19) United States
(12) Patent Application Publication
(10) Pub. No.: US 2023/0418968 A1
(43) Pub. Date: Dec. 28, 2023

(54) EVIDENCE DATA COLLECTOR USING CONTENT ADDRESSABLE STORAGE

(71) Applicant: VMware, Inc., Palo Aito, CA (US)

(72) Inventor: Shawn Rud Hartsock, Chapel Hill, NC (US)

(21) Appl. No.: 17/850,283

(22) Filed: Jun. 27, 2022

(51) Int. Cl. G06F 21/62; G06F 21/64

(52) U.S. Cl. CPC G06F 21/6227; G06F 21/64

(57) ABSTRACT

Techniques for implementing an evidence data collector (EDC) service using content addressable storage are provided. At a high level, the EDC service can receive a request for data (referred to herein as an evidence query) regarding an activity, component, or artifact of the data processing pipeline, process the evidence query by collecting the data from one or more data sources associated with the pipeline, and return a response (referred to herein as an evidence claim) that includes a reference to the collected data. In certain embodiments, the EDC service can maintain the collected data for each evidence query (or a digest of that data) in a content addressable storage system, which enables observers/verifiers to detect and remediate man-in-the-middle attacks on the EDC service.

### BACKGROUND

Unless otherwise indicated, the subject matter described in this section is not prior art to the claims of the present application and is not admitted as being prior art by inclusion in this section.

Modern software is created via a series of steps, known as a software supply chain, that begins with the software's source code and ends with delivery of the software to end-users. Typically, these steps are chained together such that the output of one step is provided as the input to another downstream step, ultimately leading to the final (i.e., delivered) software product. For example, source code can be retrieved from a source code management (SCM) system and provided as input to a compiler, which can generate a set of binaries; the binaries can be provided as input to one or more packaging scripts, which can generate an installable package; and the installable package can be provided as input to a deployment process, which can deploy the package in a production environment.

With the rising prevalence of software supply chain-based attacks such as the SolarWinds hack, it is becoming increasingly important for software vendors to provide security guarantees to customers regarding the integrity of their software supply chains. To accomplish this, software vendors must be able to collect data pertaining to their supply chains' operations in a tamper-resistant manner.

### BRIEF DESCRIPTION OF THE DRAWINGS

FIG. 1 depicts an example environment comprising an evidence data collector (EDC) service according to certain embodiments.

FIG. 2 depicts an architecture and workflow for the EDC service of FIG. 1 according to certain embodiments.

FIG. 3 depicts an evidence query processing flowchart according to certain embodiments.

FIG. 4 depicts an EDC tampering detection and remediation flowchart according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to an evidence data collector (EDC) service for a data processing pipeline such as a software supply chain. At a high level, the EDC service can receive a request for data (referred to herein as an evidence query) regarding an activity, component, or artifact of the data processing pipeline, process the evidence query by collecting the data from one or more data sources associated with the pipeline, and return a response (referred to herein as an evidence claim) that includes a reference to the collected data. The evidence claim can then be used for various purposes such as informing policy decisions, generating reports, and providing forensics in the case of a pipeline attack/compromise.

In certain embodiments, the EDC service can maintain the collected data for each evidence query (or a digest of that data) in a content addressable storage system, which is a type of storage system that assigns globally unique content identifiers (CIDs) to files based on their data content and addresses the files using these CIDs (rather than using location-based identifiers). This allows observers/verifiers to easily detect and remediate man-in-the-middle attacks on the EDC service, such as attack in which an adversary surreptitiously replaces the collected data for an evidence query with their own, malicious data.

### 2. Example Environment and EDC Architecture/Workflow

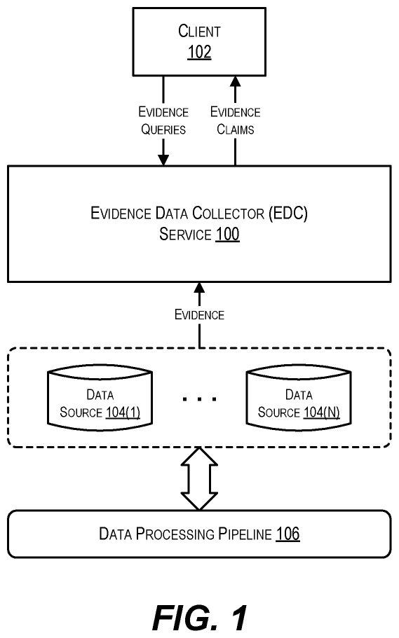

FIG. 1 depicts an example environment comprising an EDC service 100 in accordance with embodiments of the present disclosure. As shown, EDC service 100 is communicatively coupled with a client 102 and a number of data sources 104(1)-(N) which are in turn coupled with (or in some cases part of) a data processing pipeline 106. Generally speaking, the purpose of EDC service 100 is to fulfill data requests (i.e., evidence queries) from client 102 regarding the activities/components/outputs of data processing pipeline 106 by collecting data (i.e., evidence) from data sources 104(1)-(N) and returning references to the collected data (i.e., evidence claims) to client 102. Each evidence claim can be understood as an attestation that a given state is/was observed in data processing pipeline 106.

For example, as noted in the Background section, it is becoming increasingly important for software vendors to provide assurances to their customers that their software supply chains, and thus the software built and released via those supply chains, are secure. To address this, in one set of embodiments data processing pipeline 106 may be a software supply chain and EDC service 100 may be configured to collect evidence about the software supply chain's activities and/or artifacts (e.g., code reviews, compiled binaries, package creation, etc.). In these embodiments, data sources 104(1)-(N) can correspond to various components or repositories in the software supply chain such as an SCM system, code review system, build logs, etc.

In other embodiments, data processing pipeline 106 may be any other type of data processing pipeline or system known in the art, such as a business-to-business data exchange pipeline, an extract-transform-load (ETL) pipeline for data warehousing, and so on.

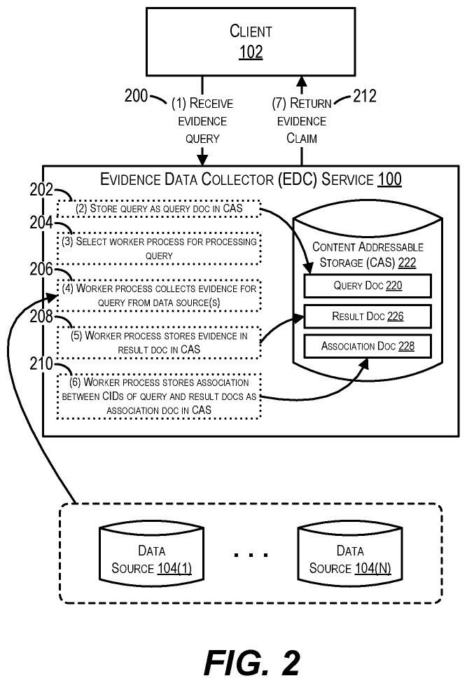

To further explain EDC service 100, FIG. 2 depicts a more detailed representation of this service and a workflow comprising steps (1)-(7)/reference numerals 200-212 that illustrates the service's high-level operation. Starting with step (1), EDC service 100 can receive an evidence query from client 102, which is a request for data of a certain kind/type pertaining to an activity, component, or artifact (i.e., output) of data processing pipeline 106. By way of example, in the scenario where data processing pipeline 106 is a software supply chain, the evidence query may include the following information:

{‘query’: ‘compliance’, ‘params’:{‘build’:1234, ‘arch’: ‘x86_64’}} Listing 1

In this example, the evidence query is a request for “compliance” data pertaining to a software build “1234” for the x86-64 architecture.

At step (2), EDC service 100 can store the evidence query as a query document 220 in a content addressable storage system 222. As mentioned previously, a content addressable storage system is a type of storage system that assigns globally unique CIDs to files based on their data content and addresses the files using these CIDs rather than using location-based identifiers. Accordingly, the storage of query document 220 in system 222 results in the assignment of a globally unique CID to query document 220. Typically, these CIDs are computed via cryptographic hashing or distributed hash trees, which means that (1) if two byte sequences are identical, they will resolve to the same CID, and (2) if the data content of a file held in system 222 changes, then its CID will also change. One example of a content addressable storage system is a storage system that employs the Inter Planetary File System (IPFS).

At step (3), EDC service 100 can select a worker process for processing the evidence query and can pass the information in the query (or the CID of query document 220) to the worker process. In various embodiments, EDC service 100 can perform this selection based on the type/kind of evidence specified in the evidence query. For instance, in the example above where the evidence query is a request for “compliance” data, EDC service 100 may select a worker process from among a pool of worker processes that is specifically configured to handle “compliance” evidence queries. As part of step (3), EDC service 100 may also store a registered digest (e.g., cryptographic hash) of the selected worker process in content addressable storage system 222 that indicates the process's authenticity.

The worker process can then process the evidence query by collecting appropriate evidence for the query from one or more of data sources 104(1)-(N) (step (4)), storing the collected evidence in a result document 226 in content addressable storage system 222, resulting in a globally unique CID for the result document (step (5)), and storing an association between the CID of query document 220 and the CID result document 226 in the form of an association document 228 in system 222 (step (6)). For example, if the CID of query document 220 is “md5:fcfd2a1bfc987d82032654a2b003dde9” and the CID of result document 226 is “md5:68b9ab0135c737922290a0b9d4c8c863,” the association created and stored at step (6) may comprise the following:

{ ‘\query’ : ‘md5:fcfd2albfc987d82032654a2b003dde9’, ‘result’:
‘md5:68b9ab0135c737922290a0b9d4c8c863’}
Listing 2

Finally, at step (7), EDC service 100 can generate and return an evidence claim to client 102 that includes the CID of result document 226 and the workflow can end.

With the high-level EDC architecture and workflow shown in FIG. 2, a number of advantages are realized. First, by storing the data collected for the evidence query in result document 226, EDC service 100 can efficiently process a duplicate submission of that query (potentially submitted months or years later) by retrieving the existing results document, rather than re-executing the data collection process at step (4).

Second, in the case where an adversary perpetrates a man-in-the-middle attack by replacing result document 226 with their own, malicious version, the CID of result document 226 will change per the intrinsic properties of content addressable storage system 222. Accordingly, this attack can be easily detected by observers residing at different network vantage points. Further, upon detecting such an attack, an observer can remediate it by re-executing the evidence query using stored query document 220 (which is identified as being linked to result document 226 via association document 228) and the original worker process (which is identified via its stored hash). This assumes that the evidence query processing is deterministic and its output will not change over time, as long as the same inputs and query processing logic is used.

The remaining sections of the present disclosure provide additional details regarding the evidence query processing performed by EDC service 100 and the tampering detection and remediation that may be performed by an observer/verifier according to certain embodiments. It should be appreciated that FIGS. 1 and 2 are illustrative and not intended to limit embodiments of the present disclosure. For example, although the workflow of FIG. 2 indicates that result document 226 is specifically stored in content addressable storage system 222, in some embodiments the result document may be stored in a different storage location and system 222 may hold a cryptographic certificate of the result document's digest and its storage location. In these embodiments, EDC service 100 may associate the CID of the certificate with the CID of query document 220 in association document 228.

Further, although not shown in FIG. 2, in some embodiments EDC service 100 may assign conventional POSIX-style paths to documents held in content addressable storage system 222 (e.g., query document 220, result document 226, and association document 228) as a means for easily tagging/tracking those documents, separately from their respective CIDs.

Yet further, in some embodiments EDC service 100 may treat content addressable storage system 222 as a cache and “age-out” stored documents after some period of time (or after some other criterion is met), thereby removing those documents from storage system 222. This can be useful if, for example, the administrators of EDC service 100 wish to force duplicate evidence queries to be re-executed on a periodic basis, rather than having such duplicate evidence queries be fulfilled via cached result documents.

### 3. Evidence Query Processing

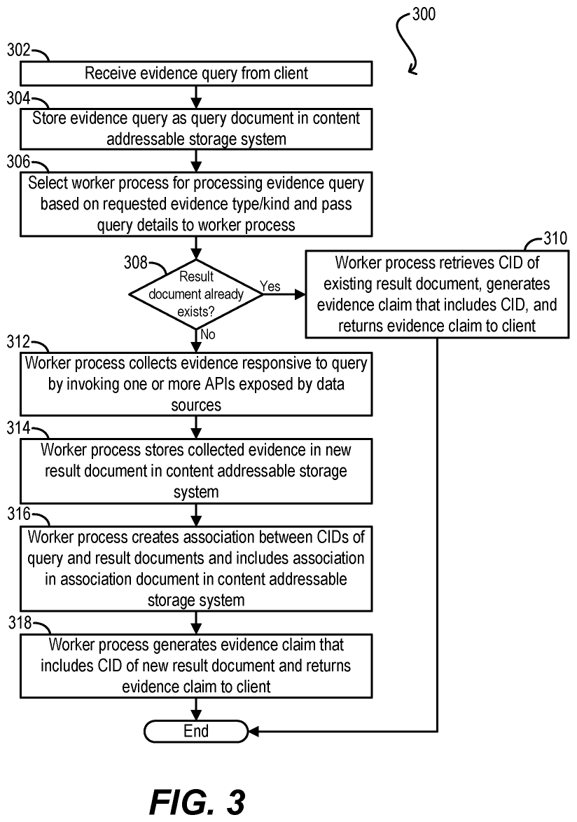

FIG. 3 depicts a flowchart 300 that provides additional details regarding the processing that may be performed by EDC service 100 for handling an evidence query according to certain embodiments.

Starting with steps 302 and 304, EDC service 100 can receive an evidence query from client 102 and store the evidence query as a query document within content addressable storage system 222, resulting in a CID for the query document. As mentioned previously, this evidence query can include a type/kind of evidence requested (e.g., compliance) and one or more parameters for carrying out the query (e.g., build number, build type, data source, etc.). The resulting CID is a globally unique identifier that is analogous to a cryptographic hash of the query document's data content.

At step 306, EDC service 100 can select a worker process for executing the evidence query based on the evidence type/kind and can pass the query details (or the CID of the query document) to the selected worker process. In response, the worker process can check whether there is an existing result document for the evidence query in content addressable storage system 222 (step 308). In various embodiments, the worker process can perform this check by search for an association document in storage system 222 that includes the CID of the query document.

If the answer is yes, the worker process can retrieve the CID of the existing result document, generate an evidence claim that includes that CID, and return the evidence claim to client 102 (step 310).

However, if the answer at step 308 is no. the worker process can conclude that this evidence query has not been processed before. Accordingly, the worker process can collect evidence that is responsive to the query by invoking one or more application programming interfaces (APIs) exposed by data sources 104(1)-(N) (step 312) and can store the collected evidence in a new result document in content addressable storage system 222, resulting in a CID for the result document (step 314). As part of step 314, the worker process may optionally transform the evidence to a desired format and cryptographically sign a digest of its contents (thereby attesting to the authenticity of the evidence).

The worker process can then create an association between the CID of the query document and the CID of the result document and include this association in a new association document content addressable storage system 222 (step 316).

Finally, the worker process can generate an evidence claim that includes the CID of the result document created at step 314 and EDC service 100 can return the evidence claim to client 102 (step 318).

### 4. Tampering Detection and Remediation

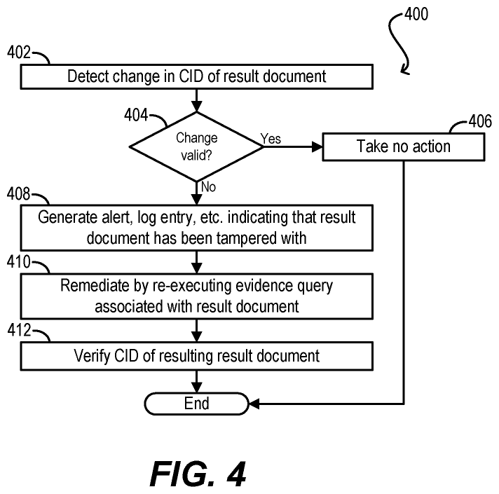

FIG. 4 depicts a flowchart 400 that may be performed by an observer entity (e.g., an auditor, security control node, etc.) detecting tampering of a result document held in content addressable storage system 222 of EDC service 100 and remediating the tampering according to certain embodiments.

Starting with step 402, the observer can detect or be alerted to a change to in the CID of the result document, thereby indicating that the data content of the result document has been modified. For example, the observer may be subscribed to receive CID change events within content addressable storage system 222.

At step 404, the observer can check whether the change to the result document is “valid” or in other words was performed by an authorized entity. For example, the observer may check whether the result document includes a reference to a previous CID as the “parent” of the current version of the result document. If the answer is yes, the observer can take no further action (step 406) and the flowchart can end.

However, if the answer at step 404 is no, the observer can generate an alert, log entry, or the like indicating that the result document has been tampered with (step 408). In addition, the observer can remediate the tampering by re-executing the evidence query associated with the result document (step 410). In one set of embodiments, this can involve retrieving the query document associated with the result document (per the association document) in content addressable storage system 222 and re-running the evidence query processing using the same worker process (identified via its registered digest). Once the evidence query has been re-executed, the CID of the resulting result document can be verified and being identical to the CID of the original (i.e., untampered) result document (step 412) and the workflow can end.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system implementing an evidence data collector (EDC) service, an evidence query from a client, the evidence query corresponding to a request for data pertaining to operation of a data processing pipeline;
storing, by the computer system, the evidence query as a query document in a content addressable storage system, the storing of the evidence query resulting in a first content identifier (CID) that uniquely identifies content of the query document;
collecting, by the computer system, data responsive to the evidence query from one or more data sources associated with the data processing pipeline;
storing, by the computer system, the collected data in a result document in the content addressable storage system, the storing of the collected data resulting in a second CID that uniquely identifies content of the result document;
storing, by the computer system, an association between the first CID and the second CID in an association document in the content addressable storage system; and
returning, by the computer system, the second CID to the client.

2. The method of claim 1 further comprising, prior to the collecting:
determining whether the result document already exists in the content addressable storage system; and
upon determining that the result document already exists, returning the second CID to the client without executing the collecting.

3. The method of claim 2 wherein the determining comprises:
checking for an association document in the content addressable storage system that includes the first CID.

4. The method of claim 1 further comprising:
detecting a change in the second CID;
in response to the detecting, generating an alert or log entry indicating that the result document has been tampered with.

5. The method of claim 4 further comprising:
re-executing the evidence query using the query document.

6. The method of claim 1 wherein the result document is aged out from the content addressable storage system according to a cache eviction policy.

7. The method of claim 1 wherein the data processing pipeline is a software supply chain and wherein the one or more data sources are components or data repositories of the software supply chain.

8. A non-transitory computer readable storage medium having stored thereon program code executable by a computer system implementing an evidence data collector (EDC) service, the program code embodying a method comprising:
receiving an evidence query from a client, the evidence query corresponding to a request for data pertaining to operation of a data processing pipeline;
storing the evidence query as a query document in a content addressable storage system, the storing of the evidence query resulting in a first content identifier (CID) that uniquely identifies content of the query document;
collecting data responsive to the evidence query from one or more data sources associated with the data processing pipeline;
storing the collected data in a result document in the content addressable storage system, the storing of the collected data resulting in a second CID that uniquely identifies content of the result document;
storing an association between the first CID and the second CID in an association document in the content addressable storage system; and
returning the second CID to the client.

9. The non-transitory computer readable storage medium of claim 8 wherein the method further comprises, prior to the collecting:
determining whether the result document already exists in the content addressable storage system; and
upon determining that the result document already exists, returning the second CID to the client without executing the collecting.

10. The non-transitory computer readable storage medium of claim 9 wherein the determining comprises:
checking for an association document in the content addressable storage system that includes the first CID.

11. The non-transitory computer readable storage medium of claim 8 wherein the method further comprises:
detecting a change in the second CID;
in response to the detecting, generating an alert or log entry indicating that the result document has been tampered with.

12. The non-transitory computer readable storage medium of claim 11 wherein the method further comprises:
re-executing the evidence query using the query document.

13. The non-transitory computer readable storage medium of claim 8 wherein the result document is aged out from the content addressable storage system according to a cache eviction policy.

14. The non-transitory computer readable storage medium of claim 8 wherein the data processing pipeline is a software supply chain and wherein the one or more data sources are components or data repositories of the software supply chain.

15. A computer system implementing an evidence data collector (EDC) service, the computer system comprising:
a processor;
a content addressable storage system; and
a non-transitory computer readable medium having stored thereon program code that, when executed, causes the processor to:
receive an evidence query from a client, the evidence query corresponding to a request for data pertaining to operation of a data processing pipeline;
store the evidence query as a query document in the content addressable storage system, the storing of the evidence query resulting in a first content identifier (CID) that uniquely identifies content of the query document;
collect data responsive to the evidence query from one or more data sources associated with the data processing pipeline;
store the collected data in a result document in the content addressable storage system, the storing of the collected data resulting in a second CID that uniquely identifies content of the result document;
store an association between the first CID and the second CID in an association document in the content addressable storage system; and
return the second CID to the client.

16. The computer system of claim 15 wherein the program code further causes the processor to, prior to the collecting:
determine whether the result document already exists in the content addressable storage system; and
upon determining that the result document already exists, return the second CID to the client without executing the collecting.

17. The computer system of claim 16 wherein the program code that causes the processor to determine whether the result document already exists comprises program code that causes the processor to:
check for an association document in the content addressable storage system that includes the first CID.

18. The computer system of claim 15 wherein the program code further causes the processor to:
detect a change in the second CID;
in response to the detecting, generate an alert or log entry indicating that the result document has been tampered with.

19. The computer system of claim 18 wherein the program code further causes the processor to:
re-execute the evidence query using the query document.

20. The computer system of claim 15 wherein the result document is aged out from the content addressable storage system according to a cache eviction policy.

21. The computer system of claim 15 wherein the data processing pipeline is a software supply chain and wherein the one or more data sources are components or data repositories of the software supply chain.
